(19) United States
(12) Patent Application Publication
(10) Pub. No.: US 2026/0142907 A1
(43) Pub. Date: May 21, 2026

(54) TESTING PLATFORM FOR CELLULAR NETWORKS

(71) Applicant: DISH Wireless L.L.C., Littleton, CO (US)

(72) Inventors: Tamanna Kawatra, Littleton, CO (US); Maria Manisha Miranda, Denver, CO (US)

(21) Appl. No.: 18/952,786

(22) Filed: Nov. 19, 2024

(51) Int. Cl. H04L 43/55; H04L 41/22

(52) U.S. Cl. CPC H04L 43/55; H04L 41/22

(57) ABSTRACT

A testing platform is described for testing new cellular network components. The testing platform is vendor-agnostic and application programming interface (API) driven. A user interface layer is provided by which a user can at least define a test campaign (including a device under test (DUT) and test parameters), trigger a test, and obtain test results. An orchestration layer can use the test campaign information to provision network resources of a laboratory end-to-end cellular network (LEEN), to interface with one or more vendor test engines (VTEs) to deploy and test the DUT in the LEEN, and to generate test results and publish the results to the user via the user interface layer. The orchestration layer interfaces with the VTEs using vendor-specific APIs.

### BACKGROUND OF THE INVENTION

Modern cellular networks include a large amount of infrastructure made up of large numbers of components with a wide variety of functions. Many entities seek to design new components for those networks and desire to test those components in as real-world of an environment as possible. However, many factors tend to limit the ability of those entities to fully test their component designs. For example, such entities typically do not have sufficient access to cellular network infrastructures for testing, to testing engines for running desired tests, to expertise in configuring environments and components beyond the component they are designing and trying to test, to industry standards and/or benchmarks, etc.

### BRIEF SUMMARY OF THE INVENTION

Systems and methods are described for testing new cellular network components. The testing platform is vendor-agnostic and application programming interface (API) driven. A user interface layer is provided by which a user can at least define a test campaign (including a device under test (DUT) and test parameters), trigger a test, and obtain test results. An orchestration layer can use the test campaign information to provision network resources of a laboratory end-to-end cellular network (LEEN), to interface with one or more vendor test engines (VTEs) to deploy and test the DUT in the LEEN, and to generate test results and publish the results to the user via the user interface layer. The orchestration layer interfaces with the VTEs using vendor-specific APIs.

Some embodiments include a smart layer with advanced artificial intelligence (AI) driven capabilities to enhance the robustness and efficiency of the testing framework. For example, embodiments can include a recommendation system that leverages historical test data to suggest optimal configurations and setups for vendors, particularly targeting those that have historically failed compliance. By analyzing past test results, some implementations of the AI can automatically provide alternative configurations to improve compliance rates. Some embodiments further employ machine learning models to dynamically generate new test scenarios beyond the pre-defined cases. This adaptive approach allows the system to identify and test edge cases or under-tested scenarios, ensuring comprehensive coverage and robust validation. Such models can facilitate sophisticated failure classification and root cause analysis capabilities, such as to classify test failures accurately and identify their underlying causes, provide actionable insights to address issues promptly and effectively, etc.

### BRIEF DESCRIPTION OF THE DRAWINGS

FIG. 1 illustrates an embodiment of a cellular network system, according to certain embodiments.

FIG. 2 illustrates a partial network infrastructure including an exemplary core in communication with access networks, according to certain embodiments.

FIG. 3 shows a block diagram of a testing environment for a cellular network component, according to embodiments described herein.

FIG. 4 shows an architecture diagram of an illustrative implementation of a testing environment, according to some embodiments described herein.

FIG. 5 shows a flow diagram of an illustrative method for testing cellular network components using a cellular test environment.

FIG. 6 provides a schematic illustration of an embodiment of a computational system that can implement various system components and/or perform various steps of methods provided by various embodiments.

### DETAILED DESCRIPTION OF THE INVENTION

### Overview

Aspects of the disclosed technology provide a testing platform for new cellular network components. Embodiments of the testing platform are vendor-agnostic and application programming interface (API) driven. A user interface layer is provided by which a user can at least define a test campaign (including a device under test (DUT) and test parameters), trigger a test, and obtain test results. An abstraction layer can use the test campaign information to provision network resources of a laboratory end-to-end (E2E) cellular network (LEEN) and to interface with one or more vendor test engines (VTEs) to deploy and test the DUT in the LEEN. The LEEN can include radio access network (RAN) components, core network components, and transport network components. An observation layer can generate test results and publish the results to the user via the user interface layer.

### Example Systems and Methods

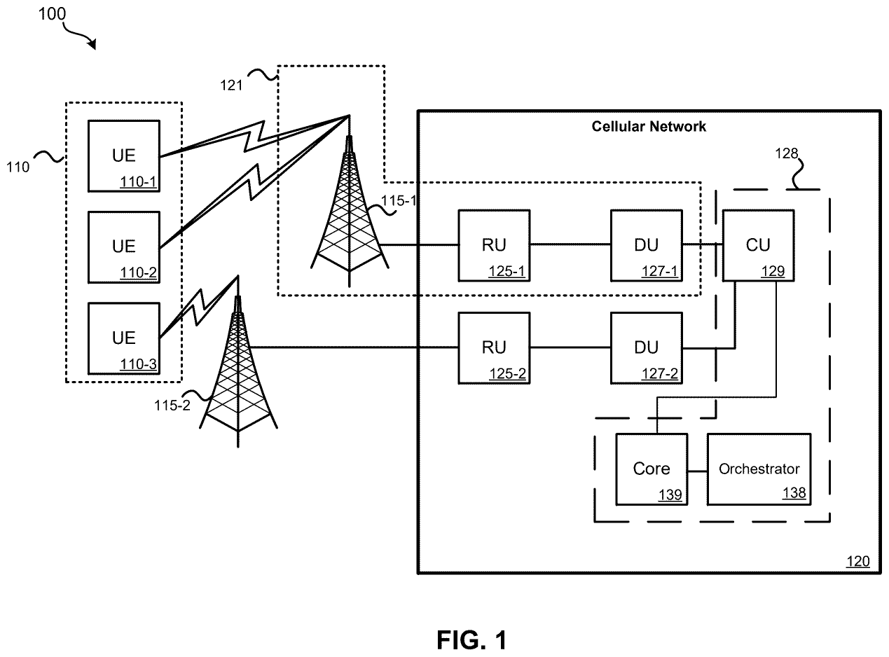

FIG. 1 illustrates an embodiment of a cellular network system 100 (“system 100”), according to certain embodiments. System 100 can include a fifth generation (5G) New Radio (NR) cellular network; other types of cellular networks, such as fourth generation (4G) long-term evolution (LTE) cellular network, sixth generation (6G) cellular network, seventh generation (7G) cellular network, etc. are also possible. System 100 can include: UE 110 (UE 110-1, UE 110-2, UE 110-3); base station 115; cellular network 120; radio units 125 (“RUs 125”); distributed units 127 (“DUs 127”); centralized unit 129 (“CU 129”); core 139, and orchestrator 138. FIG. 1 represents a component level view. In a virtualized open radio access network (O-RAN), because components can be implemented as software in the cloud, except for components that receive and transmit RF, the functionality of various components can be shifted among different servers, for which the hardware may be maintained by a separate (e.g., public) cloud-service provider, to accommodate where the functionality of such components is needed.

Although not explicitly shown, the various components of the system 100 communicate via a transport fabric. The transport fabric is responsible for the efficient and reliable transmission of data, control signals, and synchronization information across the network. It leverages high-speed, low-latency networking technologies, such as Ethernet, fiberoptics, and wireless backhaul, to ensure seamless communication between the distributed O-RAN components, such as between gNodeB components. The transport fabric also includes mechanisms for quality of service (QoS) to prioritize critical data traffic and ensure reliable service delivery, as well as redundancy and failover capabilities to maintain network stability and resilience in the face of component failures or disruptions. For example, the transport fabric includes protocols, such as Ethernet protocols, Internet Protocol (IP), Multiprotocol Label Switching (MPLS), Transmission Control Protocol/User Datagram Protocol (TCP/UDP), Passive Optical Network (PON) protocols (e.g., Gigabit Passive Optical Network (GPON) and Ethernet Passive Optical Network (EPON)), synchronization protocols (e.g., Precision Time Protocol (PTP) and Network Time Protocol (NTP)), security protocols (e.g., Internet Protocol Security (IPsec) and Transport Layer Security (TLS), Software-Defined Networking (SDN) protocols, etc.

UE 110 can represent various types of end-user devices, such as smartphones, cellular modems, cellular-enabled computerized devices, sensor devices, manufacturing equipment, gaming devices, access points (APs), any computerized device capable of communicating via a cellular network, etc. UE can also represent any type of device that has incorporated a cellular (e.g., 5G) interface, such as a 5G modem. Examples include sensor devices, Internet of Things (IoT) devices, manufacturing robots; unmanned aerial (or land-based) vehicles, network-connected vehicles, environmental sensors, etc. UE 110 may use RF to communicate with various base stations of cellular network 120. Two base stations 115 (BS 115-1, 115-2) are illustrated. Real-world implementations of system 100 can include many (e.g., hundreds, thousands) base stations, and many RUs, DUs, and CUs. BS 115 can include one or more antennas that allow RUs 125 (e.g., RU 125-1 and RU 125-2) to communicate wirelessly with UEs 110. RUs 125 can represent an edge of cellular network 120 where data is transitioned to wireless communication. In some implementations, the radio access technology (RAT) used by RU 125 is 5G New Radio (NR). Other implementations use other RAT, such as 4G Long Term Evolution (LTE). The remainder of cellular network 120 may be based on an exclusive 5G architecture, a hybrid 4G/5G architecture, a 4G architecture, or some other cellular network architecture. Base station equipment 121 may include an RU (e.g., RU 125-1) and a DU (e.g., DU 127-1) located on site at the base station. In some embodiments, the DU may be physically remote from the RU. For instance, multiple DUs may be housed at a central location and connected to geographically distant (e.g., within a couple of kilometers) RUs.

One or more RUs, such as RU 125-1, may communicate with DU 127-1. As an example, at a possible cell site, three RUs may be present, each connected with the same DU. Different RUs may be present for different portions of the spectrum. For instance, a first RU may operate on the spectrum in the citizens broadcast radio service (CBRS) band while a second RU may operate on a separate portion of the spectrum, such as, for example, “band 71” (a radiofrequency band near 600 Megahertz allocated for cellular communications). One or more DUs, such as DU 127-1, may communicate with CU 129. Collectively, RUs, DUs, and CUs create a gNodeB, which serves as the radio access network (RAN) of cellular network 120. CU 129 can communicate with core 139. The specific architecture of cellular network 120 can vary by embodiment. Edge cloud server systems outside of cellular network 120 may communicate, either directly, via the Internet, or via some other network, with components of cellular network 120. For example, one or more DUs 127-1 may be able to communicate with an edge cloud server system without routing data through CU 129 or core 139.

At a high level, the various components of a gNodeB can be understood as follows: RUs perform RF-based communication with UE. DUs support lower layers of the protocol stack such as the radio link control (RLC) layer, the medium access control (MAC) layer, and the physical communication layer. CUs support higher layers of the protocol stack such as the service data adaptation protocol (SDAP) layer, the packet data convergence protocol (PDCP) layer and the radio resource control (RRC) layer. A single CU can provide service to multiple co-located or geographically distributed DUs. A single DU can communicate with multiple RUs.

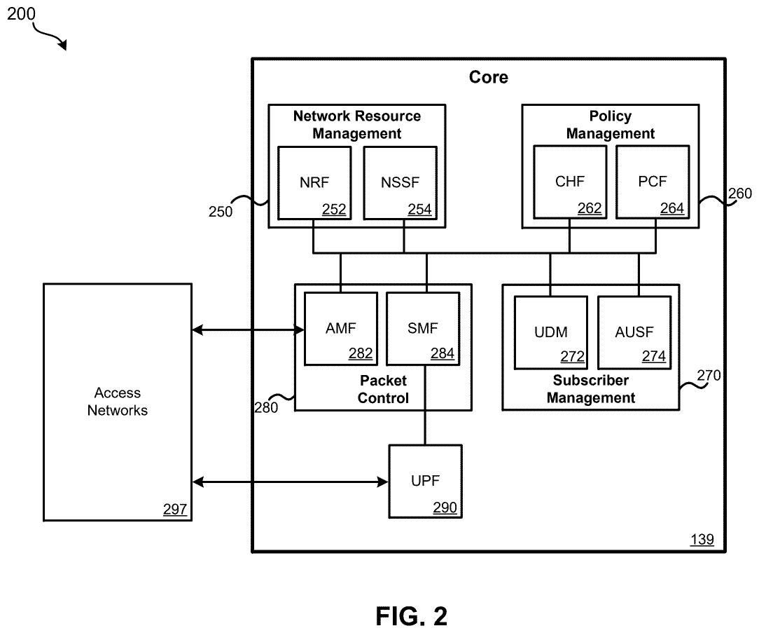

FIG. 2 illustrates a partial network infrastructure 200 including an exemplary core 139 in communication with access networks 297, according to certain embodiments. The exemplary core 139 can be physically distributed across data centers or located at a central national data center (NDC) and can perform various core functions of the cellular network. Core 139 can include: network resource management components 250; policy management components 260; subscriber management components 270; and packet control components 280. Individual components may communicate via a bus, thus allowing various components of core 139 to communicate with each other directly. Core 139 is simplified to show some key components. Implementations can involve additional components.

Network resource management components 250 can include: Network Repository Function (NRF) 252 and Network Slice Selection Function (NSSF) 254. NRF 252 can allow 5G network functions (NFs) to register and discover each other via a standards-based application programming interface (API). NSSF 254 can be used by AMF 282 to assist with the selection of a network slice that will serve a particular UE (e.g., UEs 110 of FIG. 1).

Policy management components 260 can include: Charging Function (CHF) 262 and Policy Control Function (PCF) 264. CHF 262 allows charging services to be offered to authorized network functions. Converged online and offline charging can be supported. PCF 264 allows for policy control functions and the related 5G signaling interfaces to be supported.

Subscriber management components 270 can include: Unified Data Management (UDM) 272 and Authentication Server Function (AUSF) 274. UDM 272 can allow for generation of authentication vectors, user identification handling, NF registration management, and retrieval of UE individual subscription data for slice selection. AUSF 274 performs authentication with UEs.

Packet control components 280 can include: Access and Mobility Management Function (AMF) 282 and Session Management Function (SMF) 284. AMF 282 can receive connection-and session-related information from UEs and is responsible for handling connection and mobility management tasks. SMF 284 is responsible for interacting with the decoupled data plane, creating updating and removing Protocol Data Unit (PDU) sessions, and managing session context with the User Plane Function (UPF) 290.

User plane function (UPF) 290 can be responsible for packet routing and forwarding, packet inspection, quality of service (QoS) handling, and external PDU sessions for interconnecting with a Data Network (DN) (e.g., the Internet) or various access networks 297. Access networks 297 can include the RAN of cellular network 120 of FIG. 1.

While FIGS. 1 and 2 illustrate various components of cellular network 120, it should be understood that other embodiments of cellular network 120 can vary the arrangement, communication paths, and specific components of cellular network 120. While RU 125 may include specialized radio access componentry to enable wireless communication with UE 110, other components of cellular network 120 may be implemented using either specialized hardware, specialized firmware, and/or specialized software executed on a general-purpose server system. In a virtualized arrangement, specialized software on general-purpose hardware may be used to perform the functions of components, such as DU 127, CU 129, and core 139. Functionality of such components can be co-located or located at disparate physical server systems. For example, certain components of core 139 may be co-located with components of CU 129.

Returning to FIG. 1, some O-RAN implementations of the DUs 127, CU 129, core 139, and/or orchestrator 138 are implemented virtually as software being executed by general-purpose computing equipment, such as in a data center. Therefore, depending on needs, the functionality of a DU, CU, and/or 5G core may be implemented locally to each other and/or specific functions of any given component can be performed by physically separated server systems (e.g., at different server farms). For example, some functions of a CU may be located at a same server facility as where the DU is executed, while other functions are executed at a separate server system. In the illustrated embodiment of system 100, cloud-based cellular network components 128 include CU 129, core 139, and orchestrator 138. In some embodiments, DUs 127 may be partially or fully added to cloud-based cellular network components 128. Such cloud-based cellular network components 128 may be executed as specialized software executed by underlying general-purpose computer servers. Cloud-based cellular network components 128 may be executed on a public third-party cloud-based computing platform or a cloud-based computing platform operated by the same entity that operates the RAN. A cloud-based computing platform may have the ability to devote additional hardware resources to cloud-based cellular network components 128 or implement additional instances of such components when requested. A “public” cloud-based computing platform refers to a platform where various unrelated entities can each establish an account and separately utilize the cloud computing resources, the cloud computing platform managing segregation and privacy of each entity's data.

Kubernetes, or some other container orchestration platform, can be used to create and destroy the logical DU, CU, or 5G core units and subunits, as needed, for the cellular network 120 to function properly. Kubernetes allows for container deployment, scaling, and management. As an example, if cellular traffic increases substantially in a region, an additional logical DU or components of a DU may be deployed in a data center near where the traffic is occurring without any new hardware being deployed; rather, processing and storage capabilities of the data center would be devoted to the needed functions. When the need for the logical DU or subcomponents of the DU no longer exists (i.e., when traffic subsequently decreases), Kubernetes can allow for removal of the logical DU. Kubernetes can also be used to control the flow of data (e.g., messages) and inject a flow of data to various components. This arrangement can allow for the modification of nominal behavior of various layers.

The deployment, scaling, and management of such virtualized components can be managed by orchestrator 138. Orchestrator 138 can represent various software processes executed by underlying computer hardware. Orchestrator 138 can monitor cellular network 120 and determine the amount and location at which cellular network functions should be deployed to meet or attempt to meet service level agreements (SLAs) across slices of the cellular network.

Orchestrator 138 can allow for the instantiation of new cloud-based components of cellular network 120. As an example, to instantiate a new DU, orchestrator 138 can perform a pipeline of calling the DU code from a software repository incorporated as part of, or separate from, cellular network 120; pulling corresponding configuration files (e.g., helm charts); creating Kubernetes nodes/pods; loading DU containers; configuring the DU; and activating other support functions (e.g., Prometheus, instances/connections to test tools).

A network slice functions as a virtual network operating on cellular network 120. Cellular network 120 is shared with some number of other network slices, such as hundreds or thousands of network slices. Communication bandwidth and computing resources of the underlying physical network can be reserved for individual network slices, thus allowing the individual network slices to reliably meet particular service level agreement (SLA) levels and parameters. By controlling the location and amount of computing and communication resources allocated to a network slice, the SLA attributes for UE on the network slice can be varied on different slices. A network slice can be configured to provide sufficient resources for a particular application to be properly executed and delivered (e.g., gaming services, video services, voice services, location services, sensor reporting services, data services, etc.). However, such allocations also account for resource limitations, such as to avoid allocation of an excess of resources to any particular UE group and/or application. Further, a cost may be attached to cellular slices: the greater the amount of resources dedicated, the greater the cost to the user; thus, optimization between performance and cost is desirable.

Particular network slices may only be reserved in particular geographic regions. For instance, a first set of network slices may be present at RU 125-1 and DU 127-1; and a second set of network slices, which may only partially overlap or may be wholly different from the first set, may be reserved at RU 125-2 and DU 127-2.

Further, particular cellular network slices may include some number of defined layers. Each layer within a network slice may be used to define QoS parameters and other network configurations for particular types of data. For instance, high-priority data sent by a UE may be mapped to a layer having relatively higher QoS parameters and network configurations than lower-priority data sent by the UE that is mapped to a second layer having relatively less stringent QoS parameters and different network configurations.

As illustrated in FIG. 1, UE 110 may be operating on one or more production slices of cellular network 120. As detailed later in this document, a UE that functions on a particular entity's local network may be assigned to a slice particular to the entity or a slice that provides a particular QoE for tasks to be performed by the entity's UE.

Components such as DUs 127, CU 129, orchestrator 138, and core 139 may include various software components that are required to communicate with each other, handle large volumes of data traffic, and are able to properly respond to changes in the network. In order to ensure not only the functionality and interoperability of such components, but also the ability to respond to changing network conditions and the ability to meet or perform above specifications, significant testing must be performed.

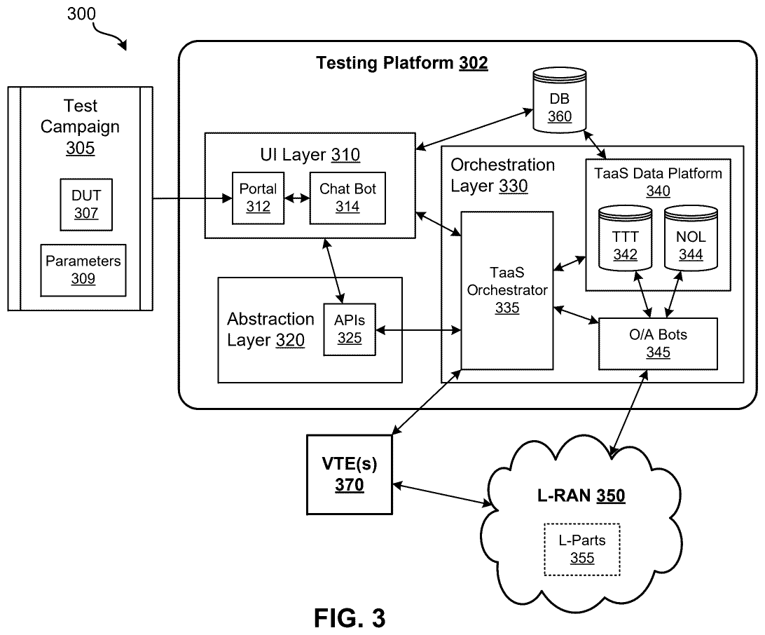

FIG. 3 shows a block diagram of a testing environment 300 for a cellular network component, according to embodiments described herein. The testing environment 300 includes a testing platform 302 in communication with one or more vendor testing engines (VTEs) 330 and a laboratory end-to-end (E2E) cellular network (LEEN). The LEEN can include radio access network (RAN) components, core network components, and transport network components. The LEEN 350 is an implementation of a full E2E O-RAN infrastructure, such as cellular network system 100 or cellular network 120 of FIG. 1. The LEEN 350 is made up of L-parts 355, each corresponding to a cellular network component. For example, the L-parts 355 include at least gNodeB components (i.e., one or more RUs, one or more CUs, and one or more DUs), a core (e.g., a 5G core), and a transport fabric. In some implementations, the core is implemented by one of the VTEs 330 as an emulated core. In such implementations, for the sake of clarity, the core is still considered to be one of the L-parts 355 making up the LEEN 350. In some implementations, the L-parts 355 further include one or more emulated access points, such as one or more UEs. The LEEN 350 is configured to (or configurable to) conform to technical specifications of a particular RAT, including any associated transport fabric properties (e.g., protocols), packet formats, communication schemes, etc. For example, the LEEN 350 can be (or can be configured as) a 5G O-RAN.

Embodiments of the LEEN 350, including any of the L-parts 355, can be implemented in a cloud-based architecture or “on-prem.” For example, in cloud-based implementations, some or all RAN components (e.g., CUs, DUs, and RUs) are virtualized and hosted on cloud infrastructure. Such cloud-based implementations can provide several features, such as supporting dynamic allocation of resources based on demand, facilitating seamless updates and maintenance, and allowing dynamic provisioning and/or deprovisioning of components. In on-prem implementations, some or all RAN components are deployed on physical hardware located within a lab environment. This approach provides direct control over the hardware, which can present certain features, such as potentially lower latency and higher performance consistency due to dedicated resources, and stricter control over the physical environment to help ensure data security and compliance.

Each VTE 330 is a testing engine with a supported set of testing capabilities and a supported set of inputs and outputs (including a supported manner in which to interface with the inputs and outputs). As one example, a first VTE 330 may support capacity testing; a second VTE 330 may support conformance, performance, and capacity testing; and a third VTE 330 may support performance and security testing. As another example, different VTEs 330 may have different cost structures and/or license fees. As another example, a first VTE 330 may be configured to use JavaScript Object Notation (JSON) for its input and output interfaces, while another VTE 330 may be configured to use eXtensible Markup Language (XML) for its input and output interfaces. Different VTEs 330 can also use different nomenclatures for different types of tests, different parameters, different outputs, etc. Different VTEs 330 can also use different types of output units, scales, etc.; so that the outputs from one VTE 330 may not be directly comparable with the outputs from another VTE 330.

In general, embodiments of the testing platform 302 facilitate vendor-agnostic (i.e., VTE-agnostic) testing of a device under test (DUT) 307, where the DUT 307 can take the place of any corresponding L-part 355 in the LEEN 350. Embodiments support running many different types of network tests on many different types of DUTs 307. In some embodiments, the DUT 307 is one of an RU, a CU, or a DU. In some embodiments, the DUT 307 is a core, or a component of a core (e.g., an AMF). In some embodiments, the DUT 307 is the transport fabric or a component of the transport fabric.

For example, as described above, the core is the central part of the O-RAN architecture responsible for managing network functions. Performance testing for the core can include latency testing, which measures the delay between request and response times using network traffic data, and throughput testing, which evaluates the maximum data rate supported by the core under various conditions using data packets of varying sizes. Scalability testing for the core can assess the core's ability to scale up or down based on the number of connected devices and traffic load, using simulated user data to gauge system performance. Conformance testing for the core can involve protocol compliance to ensure adherence to O-RAN Alliance specifications and other relevant standards (e.g., 3GPP) by using protocol-specific data, and interoperability testing to verify compatibility with other network components and different vendors, using integration testing data. Capacity testing for the core can include load testing to determine the maximum number of users and devices that can be handled efficiently, using simulated user load data, and stress testing to evaluate performance under extreme conditions, using high-stress scenarios data. Security testing for the core can encompass vulnerability scanning to identify and fix security vulnerabilities using vulnerability databases, penetration testing to simulate attacks and evaluate the robustness of security measures using attack vectors, and encryption testing to verify the effectiveness of data encryption methods using encrypted data samples.

As described above, RUs are responsible for radio signal transmission and reception. Performance testing for RUs can include signal quality testing to assess signal strength and clarity under various conditions using signal-to-noise ratio data, power efficiency testing to measure power consumption and efficiency using power usage data, and latency testing to evaluate the time taken for signal processing and transmission using signal processing time data. Conformance testing for RUs can involve RF conformance to ensure compliance with radio frequency standards using RF compliance data, and interoperability testing to check compatibility with other O-RAN components and multi-vendor environments using integration testing data. Capacity testing for RUs can include channel capacity testing to measure the maximum number of channels that can be supported simultaneously using channel usage data, and bandwidth testing to evaluate the maximum bandwidth that can be handled using bandwidth utilization data. Security testing for RUs can involve access control testing to verify that unauthorized access is prevented using access logs, and firmware security testing to ensure that the firmware is secure and free from vulnerabilities using firmware analysis data.

As described above, CUs are responsible for data processing and management functions. Performance testing for CUs can include data processing speed testing to measure the speed at which data is processed using processing time data, and latency testing to evaluate the time taken for data handling and processing using latency measurement data. Conformance testing for CUs can involve protocol compliance to ensure adherence to relevant O-RAN specifications and 3GPP standards using protocol compliance data, and interoperability testing to check compatibility with other network components using integration testing data. Capacity testing for CUs can include user capacity testing to determine the maximum number of users that can be supported using user load data, and data throughput testing to evaluate the maximum data rate using throughput measurement data. Security testing for CUs can involve data integrity testing to ensure data is not altered during transmission using integrity check data, and access control testing to verify security measures for data access using access control logs.

As described above, DUs are responsible for data processing and forwarding functions. Performance testing for DUs can include latency testing to measure the time taken for data processing and forwarding using latency measurement data, and throughput testing to evaluate the data rate capabilities using throughput measurement data. Conformance testing for DUs can involve protocol compliance to ensure compliance with O-RAN and 3GPP standards using protocol compliance data, and interoperability testing to verify compatibility with other O-RAN components using integration testing data. Capacity testing for DUs can include processing capacity testing to determine the maximum processing load using processing load data, and load testing to evaluate performance under various traffic conditions using simulated traffic data. Security testing for DUs can involve network security testing to ensure robust security measures for network communication using network security assessment data, and access control testing to verify the implementation of access controls using access control logs.

As described above, the transport fabric is the network infrastructure that connects at least the O-RAN components. Performance testing for the transport fabric can include bandwidth testing to measure the maximum bandwidth capacity using bandwidth utilization data, and latency testing to evaluate the delay in data transmission across the network using latency measurement data. Conformance testing for the transport fabric can involve network protocol compliance to ensure adherence to networking standards and protocols using protocol compliance data, and interoperability testing to verify compatibility with other network components using integration testing data. Capacity testing for the transport fabric can include load testing to determine the maximum data load that can be handled using data load measurement data, and scalability testing to assess the ability to scale with increasing network demands using scalability assessment data. Security testing for the transport fabric can involve encryption testing to verify the effectiveness of data encryption methods using encrypted data samples, and network security testing to ensure robust security for data transmission using network security assessment data.

The testing platform 302 is configured to be accessed by users. As used herein, a “user” is any entity that is providing the DUT 307, such as an entity designing a new cellular network component. A “vendor” is an entity that develops and deploys one or more VTEs 330. The testing platform 302 is provided by a testing as a service (TaaS) provider. In typical scenarios, the TaaS provider, the vendor, and the user are separate entities. The TaaS provider has one or more contractual relationships with (e.g., licenses to) one or more VTEs 330 provided by one or more vendors, and the user is a customer of the TaaS. For example, the user pays the TaaS provider for a particular test, pays for a duration of general access to the testing platform, etc.

The testing platform 302 includes a user interface (UI) layer 310, an abstraction layer 320, and an orchestration layer 330. The particular arrangement of layers and assignment of features to those layers can be changed without departing from the scope of embodiments described herein. For example, implementations can have more or fewer layers, illustrated layers can be combined, illustrated layers can be segmented, etc.

The UI layer 310 includes a portal 312 configured to receive information from user systems and to publish data to user systems. In some embodiments, the portal 312 is a web portal accessible via an Internet browser, thin client, or any other suitable means; and the web portal provides a graphical user interface (GUI) by which users can interact with features of the testing platform. For example, options, parameters, etc. can be accessible via GUI elements, such as buttons, checkboxes, text fields, graphical menus, etc.

In some embodiments, the UI layer 310 includes a chat bot 314. Interactions with the portal 312 can be fully handled by the chat bot 314, or the portal 312 can provide access to features enabled and/or facilitated by the chat bot 314. Embodiments of the chat bot 314 can be used to access any user interaction features. Some implementations of the chat bot 314 facilitate triggering of tests on DUTs 307. Some implementations of the chat bot 314 facilitate performing a root cause analysis (RCA) of a previously run test or set of tests. For example, log data is collected from some or all L-parts 355 of the LEEN 350 during one or more tests, and an RCA can be performed to find correlation patterns (as described below). Some implementations of the chat bot 314 facilitate health checks and/or diagnostics. For example, a user can ask the chat bot 314 questions using natural language queries about correlation patterns, device and/or system status, failure analyses, settings, etc.

Some implementations of the chat bot 314 facilitate general user access to one or more databases 360 (e.g., cloud-based, etc.). The database(s) 360 can be implemented as any suitable non-transitory computer-readable data storage and can have any other salient information stored thereon. In some cases, the database(s) 360 have, stored thereon, logs relating to a customer, a DUT 306, or a test campaign 305. In some cases, the database(s) 360 have, stored thereon, answer repositories, documentation, standards, specifications, benchmarks, how a user's lab is trained or set up, campaign information (e.g., how many times a DUT 307 has already been tested), previous user queries, etc.

In some embodiments, the chat bot 314 is a large language machine learning model (LLM) trained to process natural language queries received from users, to translate the queries into back-end communications with other components of the testing environment 300, and to output human-coherent and highly useful responses to those queries for output to the users. In some such embodiments, the chat bot 314 is an LLM layer trained to interact with one or more other trained machine learning networks, illustrated as observation and/or analysis (O/A) bots 345 in the orchestration layer 330 (described below). For example, the chat bot 314 may process a request for an RCA into an optimized query for input to one of the O/A bots 345 that has been trained to perform RCAs. In other embodiments, the chat bot 314 itself may include a network of several machine learning models trained for particular functions in addition to large-language features.

In some cases, a user provides the DUT 307 and other relevant test parameters 309 as part of a test campaign 305. Relevant test campaign 305 information is provided by the user via the UI layer 310 (e.g., via the portal 312 and/or the chat bot 314). The test campaign 305 can represent a comprehensive and systematic evaluation process for contextual testing of the DUT 307 (e.g., or multiple DUTs 307, multiple versions of a DUT 307, etc.). The DUT 307 can be defined with any salient technical specifications, such as hardware and software versions, supported frequencies, bandwidth capabilities, and compliance with relevant 3GPP standards.

Test parameters 309 can be provided to define and/or indicate objectives of the test campaign. For example, test parameters 309 can define relevant factors to be tested, such as signal strength, latency, throughput, error rates, handover performance, etc. In some cases, test parameters 309 can include specified environmental conditions (e.g., temperature and humidity), VTE 330 configuration parameters (e.g., for setup of emulated user equipment, generation of traffic patterns, simulation of different network scenarios, etc.), specific test cases (e.g., carrier aggregation, beamforming, Massive MIMO, etc.), etc. The test parameters 309 can also include performance benchmarks, and/or the like.

In some embodiments, the UI layer 310 is configured to run tests on a DUT 307 based on default parameters, default back-end configurations, and/or other information provided by default. In some implementations, the UI layer 310 only permits a user to provide a subset (e.g., a minimal subset) of information for the test campaign 305, otherwise relying on the default parameters and configurations. In some implementations, the UI layer 310 includes advanced configuration options that permit a user to adjust and/or provide parameters and/or configurations in place of default parameters and/or configurations, as desired. In some implementations, the UI layer 310 is configured to require at least a minimum amount of test campaign 305 information (e.g., DUT 307 definition, test parameters 309, etc.) before running a test.

The abstraction layer 320 includes application programming interfaces (APIs) 325. The APIs 325 are sets of protocols, routines, and tools that specify how software components interact and communicate with each other, effectively translating between environments. In context of the testing platform 302, the APIs 325 are designed to translate between UI layer 310 interactions (which are vendor agnostic) and vendor-specific commands and data inputs and outputs of the one or more VTEs 330. In some implementations, the APIs 325 communicate directly with the VTEs 330. In other implementations, as illustrated, the APIs 325 communication with the VTEs 330 through the orchestration layer 330.

As one example, as noted above, different VTEs 330 can use different input and output (I/O) interfaces, including I/O languages, data structures, etc. The APIs 325 can translate user input via the UI layer 310 (e.g., in a common structured format, in plain language, etc.) into the appropriate commands for whichever I/O interfaces are used by the VTE 330 selected for the requested test. Similarly, the APIs 325 can use appropriate nomenclatures, prompt the user for and/or provide default or preconfigured values for appropriate parameters, set appropriate units or scales, and/or otherwise configure user requests to conform to the I/O interfaces used by the VTE 330 selected for the requested test. As another example, different VTEs 330 can support different types of tests and/or can have different testing capabilities. When a user requests a particular type of test and/or testing capability via the UI layer 310, the UI layer 310 or the APIs 325 can automatically direct the request to whichever VTE 330 in the testing environment 300 can support the requested test and/or testing capability.

For example, a user desires to trigger performance testing of a DUT 307. In one example implementation, the user inputs a predefined vendor-agnostic command into the portal 312 (e.g., “TriggerTest(performance, CUv3)”), the portal 312 provides the command to the abstraction layer 320, and the APIs 325 translate the command to any vendor-specific commands for a particular VTE 330 involved in causing the VTE 330 (directly or indirectly) to execute the indicated test (“performance”) on the indicated DUT 307 (“CUv3”), including any supporting or otherwise salient information. In another example implementation, the user engages with the chat bot 314 through a conversational, plain language chat interface (e.g., “Please run a performance test for me in the XYZ environment on version 3 of the CU for this campaign”), the chat bot 314 parses the prompt into a meaningful set of request commands for the portal 312, the portal 312 provides the command(s) to the abstraction layer 320, and the APIs 325 translate the command(s) to any vendor-specific commands for a particular VTE 330 involved in causing the VTE 330 to execute the indicated test on the indicated DUT 307, including any supporting or otherwise salient information.

In the event that the user is triggering a test of a DUT 307 via the UI layer 310, the APIs 325 in the abstraction layer 320 would generate any VTE-compatible commands and data needed to run the indicated test on the indicated DUT 307. For example, using the previous example of running a performance test on a new CU design, typical inputs for the test can include test configuration data, such as CU specifications, network topology, traffic profiles, test scenarios, and environmental conditions. The test environment (e.g., part of the VTE 330 and/or part of the LEEN 350) includes test equipment and tools, such as signal generators, spectrum analyzers, network analyzers, and automation software. The equipment and tools are configured to be compliant with any standards and requirements, such as relevant 3GPP specifications and regulatory requirements. Further, the test environment can include any interfaces for communicating between the VTE 330 and L-parts 355 of the LEEN 350.

Such an example test can begin with a setup and configuration phase, where the CU DUT 307 is deployed with connections to the test equipment and the LEEN 350 network environment. For example, the CU DUT 307 effectively acts as a CU of the LEEN 350 (e.g., effectively replacing a corresponding one of the L-parts 355. This phase also includes loading predefined test configurations, calibrating test equipment, etc.

In a performance testing phase of such an example, a predefined set of performance-related aspects of the DUT 307 are evaluated, such as signal quality metrics like signal strength, signal-to-noise ratio (SNR), and error vector magnitude (EVM); throughput testing to measure data transfer rates; latency measurement to assess time delays in signal transmission and reception; and capacity testing to evaluate the CU's ability to handle multiple connections and high data volumes. Interference can also be conducted to assess the CU's resilience in noisy environments. Compliance and standards testing can also be performed to ensure that the CU meets 3GPP and other relevant standards for functionality, performance, and interoperability with other network elements from different vendors. In such an example, diagnostic and troubleshooting activities can include spectrum analysis to identify issues related to frequency spectrum usage and protocol analysis to examine the communication protocols used within the CU.

Typical outputs from such an example test include performance metrics, such as throughput results, latency measurements, signal quality metrics, and capacity data. Compliance and standards reports can confirm that the CU meets 3GPP and other relevant standards, and interoperability results can show the CU's ability to interoperate with other network elements. Diagnostic information can include spectrum analysis data and protocol analysis results. Automated test reports can provide both summary and detailed analyses of the test results, including pass/fail status for different scenarios, raw data, graphs, charts, and insights and recommendations based on the test results for improving CU performance and addressing any identified issues.

During and/or subsequent to executing a test by the VTE 330, the orchestration layer 330 can gather and analyze collected and generated information. As illustrated, embodiments of the orchestration layer 330 include a testing as a service (TaaS) data platform 340. The TaaS data platform 340 can include a test tracking table (TTT) 342 for gathering and storing information output by the VTE 330 in relation to executing the test. Additionally or alternatively, embodiments of the TaaS data platform 340 can include, or be in communication with, network observability logs (NOL) 344 for gathering and storing information generated by the LEEN 350 (i.e., by the L-parts 355) in relation to executing test.

Embodiments of the orchestration layer 330 include one or more observation/analysis (O/A) bots 345. The O/A bots 345 are configured to perform observation and/or analysis features. In some embodiments, one or more of the O/A bots 345 is implemented as a machine learning (ML) network trained to perform certain analyses based on data from the TTT 342 and/or the NOL 344. In some such embodiments, one of the O/A bots 345 is trained to perform a root cause analysis (RCA) of any failures encountered during execution of a test on the DUT 307 based on data in the TTT 342 and the NOL 344.

Embodiments of the orchestration layer 330 interact with the UI layer 310 to allow users to request features of the orchestration layer 330 and to receive information from features of the orchestration layer 330. For example, a user can request a root cause analysis of any encountered testing errors or failures (e.g., via the portal 312 and/or the chat bot 314), a corresponding one or more O/A bots 345 of the orchestration layer 330 can be invoked to perform the root cause analysis, and the one or more invoked O/A bots 345 can publish the results of the root cause analysis to the portal 312 and/or chat bot 314 for output to the user.

Some embodiments of O/A bots 345 trained to perform RCA are implemented as a ML network trained using a combination of supervised and unsupervised learning algorithms. The supervised learning component is trained on historical data comprising labeled instances of test failures and their known causes. This involves using classification algorithms such as decision trees, support vector machines, or neural networks to learn patterns and correlations between test inputs, execution conditions, and failure outcomes. The unsupervised learning component employs clustering techniques like k-means or hierarchical clustering to identify novel failure patterns and anomalies in the data that were not previously encountered.

The input data for such RCA-trained O/A bots 345 includes detailed logs and metrics from the TTT 342 and NOL 344. The TTT 342 can provide structured data output by test tools, including test steps, parameters, and results. For example, the TTT 342 captures the signal strength, latency, throughput, error rates, and specific test case outcomes. The NOL 344 can offer granular insights into the behavior of the LEEN 350 components (e.g., L-parts 355) during the test, such as resource utilization, network traffic patterns, and event logs. By aggregating and preprocessing this data, the ML network of the RCA-trained O/A bots 345 is trained to construct a comprehensive view of the DUT's 307 performance in the test.

The output of such RCA-trained O/A bots 345 can be a detailed RCA report that identifies the root cause of any detected failures. This report includes a diagnostic summary that highlights the specific conditions leading to the failure, the affected components, and any relevant error messages or anomalies observed in the logs. The generated report can be published for output to a computational system (e.g., for storage, trend analysis, further processing, etc.) and/or to a user via the UI layer 310.

Typical types of failures that may be encountered during the test of a DUT 307 can include signal degradation, latency spikes, packet loss, and handover failures. For instance, if a test reveals that the DUT 307 is experiencing high latency during handover operations, the RCA-trained O/A bot 345 can analyze the corresponding TTT 342 and NOL 344 entries to identify potential causes. It might detect that the latency spike coincides with high CPU utilization on a DU in the LEEN 350, suggesting that resource contention is the root cause. Alternatively, it could uncover that the handover failure is due to a misconfiguration in the signaling parameters, which can be rectified by adjusting relevant settings.

Another example could involve a scenario where the DUT 307 shows an unexpected drop in throughput. The RCA-trained O/A bot 345 can analyze the NOL 344 data to discover that this drop occurs during periods of high interference, as indicated by signal-to-noise ratio (SNR) metrics. By correlating this with TTT 342 data, the RCA-trained O/A bot 345 can determine that the failure is linked to the DUT's 307 inability to cope with fluctuating interference levels, possibly due to suboptimal antenna configurations or insufficient error correction mechanisms.

In some embodiments, O/A bots 345 are trained to provide actionable recommendations for resolving issues identified by RCA-trained O/A bots 345. Such actionable recommendations can include adjusting test parameters, reconfiguring the DUT 307, addressing specific hardware or software defects, etc. For example, if the RCA-trained O/A bots 345 determine that a test always fails at a particular testing stage, recommendations can be made for reconfiguring DUT 307 parameters, LEEN 350 configuration parameters, test parameters 309, etc. in a manner that the recommendation-trained O/A bot 345 determines is likely to pass the stage.

The ML network for such recommendation-trained O/A bots 345 can be implemented using a combination of supervised learning, reinforcement learning, and expert system techniques. Supervised learning algorithms, such as decision trees, random forests, and neural networks, are trained on historical data containing instances of test failures and their corresponding resolutions. Reinforcement learning algorithms, like Q-learning or Deep Q Networks (DQNs), are employed to iteratively refine the recommendations based on feedback from implemented solutions. Expert system techniques, including rule-based reasoning, are integrated to incorporate domain-specific knowledge and best practices into the recommendation process.

The input data for such recommendation-trained O/A bots 345 can include detailed logs and metrics from the TTT342 and NOL 344, as well as the output from the RCA process (e.g., from an RCA-trained O/A bot 345). The TTT 342 provides structured data from test tools, including test steps, parameters, and results, capturing information such as signal strength, latency, throughput, error rates, and specific test case outcomes. The NOL 344 can provide granular insights into the behavior of L-parts 355 during testing, such as resource utilization, network traffic patterns, and event logs. As noted above, the RCA output can include diagnostic summaries that highlight the specific conditions leading to failures, the affected components, and relevant error messages or anomalies observed in the logs.

The ML network can process this input data by first normalizing and aggregating it to ensure consistency. The supervised learning component uses historical data to learn patterns and correlations between test parameters, execution conditions, and successful resolutions. The reinforcement learning component iteratively improves the recommendations by evaluating the outcomes of implemented solutions and adjusting its strategies based on the observed results. The expert system component applies predefined rules and domain knowledge to provide contextually relevant recommendations.

The output of such recommendation-trained O/A bots 345 can include a set of actionable recommendations aimed at resolving the identified issues. These recommendations can be presented in a detailed report that specifies the proposed actions, the rationale behind them, and the expected outcomes. Some examples of possible RCA results and corresponding recommendations provided by such recommendation-trained O/A bots 345 include: in response to the RCA detecting high latency during handover operations, recommending reconfiguring the handover threshold parameters to optimize performance for high-speed mobility scenarios; in response to the RCA detecting packet loss under high traffic load, recommending adjusting the DUT's 307 quality of service (QoS) settings to prioritize critical traffic and ensure reliable delivery, and/or increasing the buffer size or optimizing the scheduling algorithms to handle high traffic loads more effectively; in response to the RCA detecting signal degradation due to interference, recommending reconfiguring antenna settings or deploying advanced interference mitigation techniques, such as beamforming or dynamic spectrum allocation, to enhance signal quality and reduce interference; in response to the RCA detecting a software defect leading to unexpected reboots, recommending updates or patches to specific software modules or configurations that are causing the issue, and/or recommending conducting additional tests to validate the stability of the updated software; and in response to the RCA detecting inconsistent throughput performance, recommending adjusting the test environment to better simulate real-world conditions, such as varying the traffic patterns or introducing controlled levels of interference, and/or recommending reconfiguring the DUT 307 to optimize its throughput performance under different scenarios.

Some embodiments of the O/A bots 345 are trained to synthesize aggregated result datasets from across multiple tests. The multiple tests can include different types of tests, the same or different tests on multiple DUTs 307, the same or different tests on multiple DUT 307 versions, the same or different tests on the same or different DUTs 307 in multiple LEEN 350 configurations, the same or different tests on the same or different DUTs 307 using multiple test parameters 309, etc. Correspondingly, such synthesis-trained O/A bots 345 can be trained to perform such synthesis to detect or identify changes over one or more dimension, where the dimensions can include any one or more of time, test campaign 305 identifier, DUT 307 type, DUT 307 version, LEEN 350 configuration, test parameter 309 settings, etc.

Some embodiments of the O/A bots 345 are trained to suggest and/or automatically perform adjustments to test conditions, such as to test parameters 309, DUT 307 settings, LEEN 350 configuration, L-parts 355 settings, etc. Such suggestion-trained O/A bots 345 can leverage historical test data, real-time performance metrics, and sophisticated learning algorithms. The ML network for such suggestion-trained O/A bots 345 can be implemented using a combination of reinforcement learning (e.g., Q-learning or Deep Q Networks (DQNs)) and predictive analytics (e.g., utilizing regression models, time-series analysis, decision trees, etc.).

The input data for such suggestion-trained O/A bots 345 includes historical test logs, performance metrics, and configuration parameters from both the TTT 342 and NOL 344. Historical test logs provide a record of past test cases, including the specific test parameters used, the outcomes, and any observed anomalies or failures. Performance metrics encompass a wide range of data points such as signal strength, latency, throughput, error rates, and resource utilization, gathered during the execution of previous tests. Configuration parameters detail the setup of the DUT 307 and the test environment, including hardware and software specifications, network configurations, and environmental conditions.

Such suggestion-trained O/A bots 345 can process the input data to identify patterns and correlations that can inform the design of new tests and the adjustment of existing test parameters, such as by analyzing trends in latency and throughput to determine optimal configurations for testing handover performance under varying load conditions. The reinforcement learning component allows the bot to iteratively refine its suggestions by evaluating the outcomes of newly proposed tests and adjusting its strategies based on the observed results.

The output of such suggestion-trained O/A bots 345 can include a set of recommended new tests and adjustments to existing test parameters. For instance, such an O/A bot 345 can suggest a new test case to evaluate the DUT's 307 performance under extreme interference conditions by configuring the test environment to introduce variable noise levels and monitoring the DUT's 307 signal-to-noise ratio (SNR) and error rates; or recommend adjusting the parameters of an existing test to better simulate real-world scenarios, such as modifying traffic patterns to reflect peak usage times or altering the mobility parameters to test handover performance in high-speed environments.

Some embodiments of the O/A bots 345 are trained to establish and/or confirm benchmarks and/or standards relating to O-RAN parameters, RAN components, etc. based on aggregation of large datasets from across large numbers of customers, test campaigns 305, test types, DUTs 307, test parameters 309, etc. Some such benchmark/standard-trained O/A bots 345 are further configured to anonymize, encrypt, and/or otherwise protect the privacy and integrity of data from across different customers.

The ML network for such benchmark/standard-trained O/A bots 345 can be implemented using a combination of unsupervised and supervised learning algorithms, as well as statistical analysis techniques. Unsupervised learning algorithms such as clustering (e.g., k-means, DBSCAN) and dimensionality reduction (e.g., PCA, t-SNE) can identify patterns and group similar test results. Supervised learning algorithms (e.g., regression models, random forests, and neural networks) are trained on labeled data to predict performance metrics and validate benchmarks. Statistical analysis techniques (e.g., hypothesis testing and confidence interval estimation) can ensure the robustness and reliability of the established benchmarks.

The input data for such benchmark/standard-trained O/A bots 345 can encompass a vast array of information collected from the TTT 342 and NOL 344, contributed by multiple customers, test campaigns 305, etc. The TTT 342 provides detailed records of test executions, including the specific test parameters 309, test tools (e.g., VTEs 330) used, DUT 307 configurations, and results. These parameters can include signal strength, bandwidth, latency, throughput, error rates, and/or other performance metrics. The NOL 344 can provide additional insights into the operational environment and behavior of L-parts 355, such as resource utilization, traffic patterns, and event logs.

Such benchmark/standard-trained O/A bots 345 can process the extensive dataset by first normalizing and aggregating the data to ensure consistency and comparability across different test campaigns and customers. They can then apply clustering algorithms to group similar test outcomes, identifying common performance patterns and outliers. Supervised learning models are trained on these clustered data points to predict expected performance metrics under various conditions and configurations. Statistical techniques are used to calculate confidence intervals and establish benchmarks with a high degree of certainty.

The output of such benchmark/standard-trained O/A bots 345 can include a set of established benchmarks and standards for various O-RAN parameters and RAN components. These benchmarks are presented in a comprehensive report that details the performance metrics, the conditions under which they were derived, and the statistical confidence levels. For example, the benchmark/standard-trained O/A bots 345 can establish a benchmark for handover latency, specifying that under typical network conditions and configurations, the expected latency should be within a certain range with a 95% confidence level. Some examples of possible benchmarks and standards that could be established or confirmed by this O/A bot include latency benchmarks (e.g., benchmarks for end-to-end latency for different RAN configurations, such as the latency between the RU and the DU, or between the CU and the core network), throughput standards (e.g., by aggregating data from various test campaigns, confirming throughput standards for different frequency bands and bandwidths; determining the expected maximum and average throughput for a given RU operating at a specific frequency and bandwidth; etc.), error rate benchmarks (e.g., benchmarks for acceptable error rates under different environmental conditions and traffic loads), resource utilization standards (e.g., confirming standards for CPU and memory utilization for different RAN components, such as the DU and CU, under varying traffic conditions), handover performance benchmarks (e.g., establishing benchmarks for handover success rates and latency for different mobility scenarios, such as urban, suburban, and rural environments), etc.

Embodiments of the orchestration layer 330 further include a Taas orchestrator 335 that orchestrates operations of components of the testing environment 300 across layers. The Taas orchestrator 335 can be implemented using a microservices architecture, where each service is responsible for a specific function and can communicate with other services (e.g., through well-defined APIs). This modular approach allows for scalability, maintainability, and flexibility. The Taas orchestrator 335 can leverage containerization technologies (e.g., Docker) and orchestration frameworks (e.g., Kubernetes) to manage service deployment, scaling, and fault tolerance. Communication between the Taas orchestrator 335 and other components can be facilitated through RESTful APIs, message queues (e.g., RabbitMQ, Kafka), WebSockets, and/or any other suitable framework. For instance, the Taas orchestrator 335 uses APIs 325 of the abstraction layer 320 to facilitate access by the Taas orchestrator 335 to VTEs 330 and data sources. For example, such interactions allow the Taas orchestrator 335 to initiate, configure, and control test campaigns 305 by sending specific commands and parameters to the VTEs 330 based on appropriate APIs 325.

Embodiments of the Taas orchestrator 335 also communicate with the UI layer 310. The UI layer 310 can send user commands and requests to the Taas orchestrator 335, which processes these inputs and coordinates the necessary actions. For example, when a user initiates a new test campaign 305 through the web portal, the Taas orchestrator 335 retrieves the relevant test parameters 309 and DUT 307 definitions, configures the VTEs 330 accordingly, and directs test execution. Real-time updates and results are then communicated back to the UI layer 310, allowing users to monitor the progress and outcomes of the tests.

Within the orchestration layer 330, the Taas orchestrator 335 can coordinate activities of other components, such as the TTT 342, NOL 344, and O/A bots 345. Embodiments of the Taas orchestrator 335 can ensures that data generated during test executions is properly logged and stored in the TTT 342 and NOL 344 for subsequent analysis. Embodiments of the Taas orchestrator 335 can also trigger the O/A bots 345 to perform tasks such as root cause analysis, suggesting new tests, establishing benchmarks based on the gathered data, and/or others.

Embodiments of the Taas orchestrator 335 can also handle scheduling and execution of test campaigns by leveraging a task scheduler that can prioritize and allocate resources based on the current load and availability. It can maintain a state machine to track the progress of each test campaign, ensuring that all steps are executed in the correct sequence and handling any errors or exceptions that may arise. The Taas orchestrator 335 can implement robust logging and monitoring mechanisms to track system performance, detect anomalies, and ensure the reliability of the platform.

As one example, during a test campaign involving a new RAN component (e.g., a DU), the Taas orchestrator 335 can first retrieve the DUT 307 definition and test parameters 309 via the UI layer 310. The Taas orchestrator 335 can then communicate with the APIs 325 of the abstraction layer 320 to configure appropriate one or more VTEs 330, such as by specifying test scenarios and environmental conditions. As the test progresses, the Taas orchestrator 335 can collect data from the VTEs 330, logs the data in the TTT 342 and/or NOL 344, and trigger the relevant O/A bots 345 to analyze the data and provide insights. If a failure is detected, the Taas orchestrator 335 can direct appropriate O/A bots 345 to recommend adjustments of test parameters and/or reconfigurations of the DUT 307. In some embodiments, the Taas orchestrator 335 can automatically (or in response to user direction) make the recommended adjustments, reconfigurations, etc.

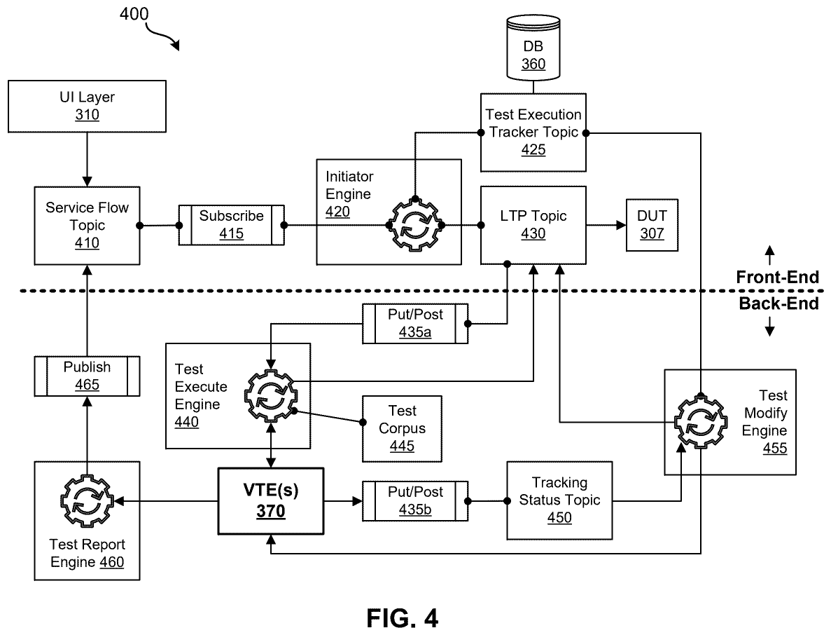

FIG. 4 shows an architecture diagram of an illustrative implementation of a testing environment 400, according to some embodiments described herein. The testing environment 400 can be an implementation of some or all of the testing environment 300 of FIG. 3. The architecture of the testing environment 400 is illustrated primarily as a set of automation engines interacting with topics. In this context, “automation engines” generally refer to computational platform components specially configured to perform predefined tasks or workflows automatically (i.e., without human intervention). The automation engines automatically react to certain events, process data, and/or trigger further actions based on specific predefined conditions.

In this context, “topics” refer to channels or feeds where messages, events, or data points are published and made available for consumption by the automation engines (and/or other components). They can effectively be intermediaries, decoupling data producers (generating and publishing data) from data consumers (processing and/or acting on the data). In a distributed system, such as the testing environment 400, topics enable components to communicate asynchronously, facilitating both real-time and delayed processing.

In some embodiments, interactions between automation engines and topics follow a publish-subscribe model. Data producers (e.g., automation engines, external systems, etc.) send events or messages to the topics. The automation engines can subscribe to the topics, continuously listening for new data. Once a relevant message is published to a topic, the automation engine can consume it, process the data according to predefined rules or logic, and produce new data or trigger further actions, as needed.

In some embodiments, each automation engine is implemented as a micro-service that can be separately deployed. For example, more, fewer, or different automation engines can be deployed within the testing environment 400 in a plug-and-play manner. In some embodiments, some or all of the testing environment 400 (e.g., except for the VTEs 330) can be implemented as an API-driven service for deployment into an architecture having one or more VTEs 330, one or more configurations of LEEN 350, etc.

The illustrated architecture can be described as having a “front-end” portion and a “back-end” portion. The front-end generally refers to user-facing components and features, while the back-end portion generally refers to server-side components and features. The of the platform, respectively. The front-end includes the UI Layer 310, and the back-end includes the orchestration layer 330, abstraction layer 320, and underlying services and databases (e.g., TTT 342, NOL 344, and database(s) 360). The VTEs 330 can be considered as part of the back-end.

As described with reference to FIG. 3, test campaign 305 information and/or user queries and interactions are received via a UI layer 310, such as via a portal 312 and/or a chat bot 314. As described herein, the UI layer 310 facilitates user interactions with the platform. It can be implemented as a web portal 312 and/or chat bot 314, offering a user-friendly interface for configuring test campaigns, monitoring progress, reviewing results, etc. The UI Layer 310 communicates with the orchestration layer 330 to relay user commands and receive updates.

Information provided via the UI layer 310 can populate a service flow topic 410. For example, the service flow topic 410 includes information defining an incident identifier, a DUT 307, and a test phase. The service flow topic 410 is a communication channel within the platform, implemented using messaging protocols such as MQTT or Kafka. It facilitates the flow of service-related data and commands between different components of the platform, such as to ensure that service requests (e.g., test initiation or parameter adjustments) are efficiently routed to the appropriate modules for processing.

An initiator engine 420 (an automation engine) is a subscriber (indicated by subscribe module 415) to the service flow topic 410. The subscribe module 415 is responsible for subscribing to various topics within the platform, so that relevant data and commands are received by the appropriate components. The initiator engine 420 is responsible for initiating test campaigns based on user input received from the UI Layer 310. It processes the test parameters 309 and DUT 307 definitions, configuring settings to start test execution. The initiator engine 420 communicates with the APIs 325 of the abstraction layer 320 to set up the VTEs 330 and the DUT 307.

The initiator engine 420 is coupled with a test execution tracker topic 425 and a LTP (log, track, and process) topic 430. The test execution tracker topic 425 can be a monitoring channel for tracking the progress of test executions. It can be implemented using messaging systems and can collect real-time data on the status of each test campaign, including test steps, results, and any encountered issues. The test execution tracker topic 425 can allow the Taas orchestrator 335 (see FIG. 3) and other components to monitor ongoing tests and make adjustments as needed. It can help to ensure that test executions are closely tracked and that relevant data is available for analysis. In one implementation, the test execution tracker topic 425 maintains, for each incident (identified by an “incident identifier”), an associated test phase, DUT 307, identifier of the test campaign 305, test campaign execution identifier and status, and test suite label.

The LTP topic 430 can be a communication channel dedicated to logging, tracking, and processing test-related data. Some implementations can aggregate logs from various VTEs 330 and DUTs 307 (e.g., for subsequent analysis). The LTP topic 430 can maintain a comprehensive record of test activities, such as for diagnosing issues, performing root cause analysis, generating reports, etc. In one implementation, the LTP topic 430 maintains information related totest line identifiers, test configuration identifiers, incident identifiers, DUT 307, test phase, etc.

A test execute engine 440 (an automation engine) is coupled with the LTP topic 430 via a put/post module 435a. The put/post modules 435 are generally responsible for sending and posting data to various topics and components within the platform. For example, the put/post modules 435 help to ensure that test results, logs, and other relevant data are correctly routed to the appropriate destinations, such as the TTT 342, NOL 344, and the test report engine 460 (described below).

The test execute engine 440 is the core component responsible for executing test cases. It interfaces with the VTEs 330 through the APIs 325 of the abstraction layer 320, sending commands and receiving data. The test execute engine 440 directs the VTEs 330 to help ensure that test cases are executed according to the defined test parameters 309 and/or other parameters and to collect performance metrics and results from the VTEs 330.

In some embodiments, the platform includes a test corpus 445. The test corpus 445 is a repository of predefined test cases and scenarios, which can include a comprehensive set of tests designed to evaluate different aspects of a DUT's 307 performance, conformance, security, interoperability, etc. In some implementations, the test corpus 445 provides a set of default tests and test configurations that can be accessed or queried via the UI layer 310.

During execution of tests by VTEs 330, updates can be sent to a tracking status topic 450 via a put/post module 435b. The tracking status topic 450 is a communication channel that provides updates on the tracking status of test campaigns 305. It can help to ensure that the progress and status of tests are continuously monitored and reported, allowing for real-time adjustments and interventions, if necessary.

The updates tracked by the tracking status topic 450 can be communicated to a test modify engine 455, which can also be in communication with the test execution tracker topic 425 and the LTP topic 430. The test modify engine 455 can also communicate back to the VTEs 330. The test modify engine 455 can be responsible for adjusting test parameters 309 and configurations based on real-time data. In some embodiments, the adjustments are made based on recommendations and/or instructions from the O/A bots 345. For example, the test modify engine 455 helps to ensure that tests can be dynamically modified to optimize performance and address any issues that arise during execution.

The VTEs 330 can output data to a test report engine 460. The test report engine 460 can be responsible for generating detailed reports based on the data collected during test campaigns 305. The test report engine 460 can compile test results, performance metrics, analysis from the O/A bots 345, and/or any other salient information into comprehensive reports that provide insights into the DUT's 307 performance. In some cases, the reports can identify issues, recommendations, etc. The test report engine 460 can also communicate (e.g., via a publish module 465) to the service flow topic 410. For example, this can facilitate user access, via the UI layer 310, to the test reports and/or information in those reports.

As one example, execution of a performance test for a DUT 307 begins when a user provides necessary inputs via the UI layer 310. The user, through a web portal 312 or chat bot 314, specifies the DUT 307 and technical specifications, test parameters 309, and desired test scenarios. This input is transmitted to the Taas orchestrator 335 within the orchestration layer 330, which processes the user's commands and retrieves any additional required configurations (e.g., from the test corpus 445). Upon receiving the user input, the initiator engine 420 is activated to set up the test campaign 305 and it configures initial settings and parameters for the VTEs 330 and the DUT 307, ensuring that all prerequisites are met. The Taas orchestrator 335 communicates with the abstraction layer 320 via APIs 325 to relay these configurations to the VTEs 330. The abstraction layer 320 translates high-level commands into the specific protocols required by the abstraction layer 320.

The test execute engine 440 can takes over to initiate the execution of the test by sending commands to the VTEs 330 to start the test according to the defined parameters. The VTEs 330 generate and transmit signals, measure responses, and collect performance metrics such as signal strength, latency, throughput, and error rates. Throughout this process, the test execution tracker topic 425 monitors the status and progress of the test, continuously updating the Taas orchestrator 335 with real-time data. Concurrently, the TaaS data platform 340 (e.g., TTT 342 and NOL 344) is populated with detailed logs and metrics captured during the test execution, including comprehensive information about the test steps, parameters, DUT 307 behavior, and any anomalies encountered.

If any issues or anomalies are detected during the test, the Taas orchestrator 335 triggers the relevant O/A bots 345 to perform diagnostics. For example, if a high latency is observed, an RCA-trained O/A bot 345 TaaS data platform 340 to determine the root cause, such as resource contention or misconfiguration. Based on this analysis, the RCA-trained O/A bot 345 provides actionable recommendations, which can be relayed back to the Taas orchestrator 335. The Taas orchestrator 335 can then use the test modify engine 455 to dynamically adjust test parameters 309, reconfigure the DUT 307, reconfigure VTEs 330, reconfigure L-parts 355, etc.

Throughout the test, the Taas orchestrator 335 can continuously communicate and synchronize between components, including managing the flow of data between the UI layer 310, abstraction layer 320, and modules within the orchestration layer 330. Upon completion of the test, the test report engine 460 compiles all the collected data into a comprehensive report, including detailed performance metrics, analysis results from the O/A bots 345, recommendations for improvements, etc. The Taas orchestrator 335 can send the test report back to the UI layer 310 so that the user can review the results via the web portal 312 or chat bot 314.

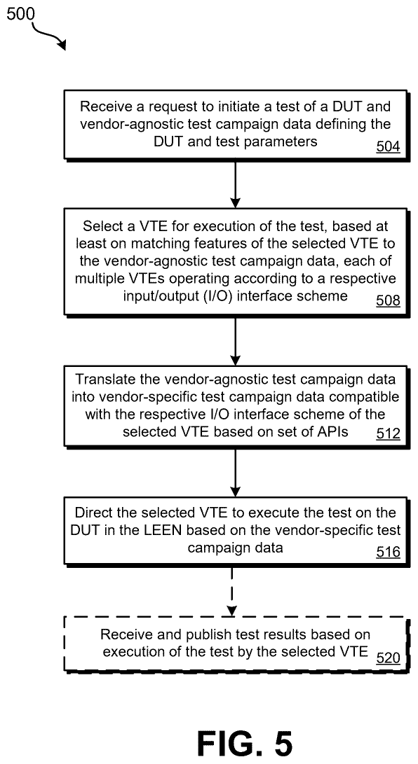

FIG. 5 shows a flow diagram of an illustrative method 500 for testing cellular network components using a cellular test environment. As described herein, the test environment includes a test platform, a plurality of vendor test equipment platforms (VTEs), and a laboratory end-to-end (E2E) cellular network (LEEN). Each of the VTEs operates according to a respective input/output (I/O) interface scheme. For example, the I/O scheme can define what data and commands are received by each particular VTE, in which formats, using which protocols, etc.; and what data and commands are output by each particular VTE, in which formats, in which units or scales, using which protocols, etc. The I/O scheme can be proprietary and/or vendor-specific. It is assumed that different VTEs have different I/O schemes, so that instruction and data sets used by one VTE may not be compatible with another VTE.

Embodiments can begin at stage 504 by receiving (e.g., by an orchestration layer of the test platform via a user interface (UI) of a UI layer of the test platform) a request to initiate a test of a device under test (DUT) and vendor-agnostic test campaign data defining the DUT and test parameters. As described herein, the DUT is a cellular network component, such as a RAN component (a CU, DU, or RU), a core network component, or a transport network component. In some embodiments, requesting the test involves selecting the test from a stored test corpus of predefined tests.

At stage 508, embodiments can select (e.g., by the orchestration layer) a VTE of the plurality of VTEs for execution of the test. The selection can be based at least on matching features of the selected VTE to the vendor-agnostic test campaign data. For example, the VTE can be selected based on which VTE has the best capabilities for executing the requested test, which can execute the test at a lowest cost or with lowest resource usage, etc.

At stage 512, embodiments can translate (e.g., by an abstraction layer of the test platform) the vendor-agnostic test campaign data into vendor-specific test campaign data compatible with the respective I/O interface scheme of the selected VTE based on a set of APIs. At stage 516, embodiments can direct (e.g., by the orchestration layer) the selected VTE to execute the test on the DUT in the LEEN based on the vendor-specific test campaign data.

Some embodiments, at stage 520, can receive (e.g., by the orchestration layer) test results based on execution of the test by the selected VTE. Such embodiments can further (also at stage 520) publish the test results for output. For example, the test results can be published for output via a user interface.

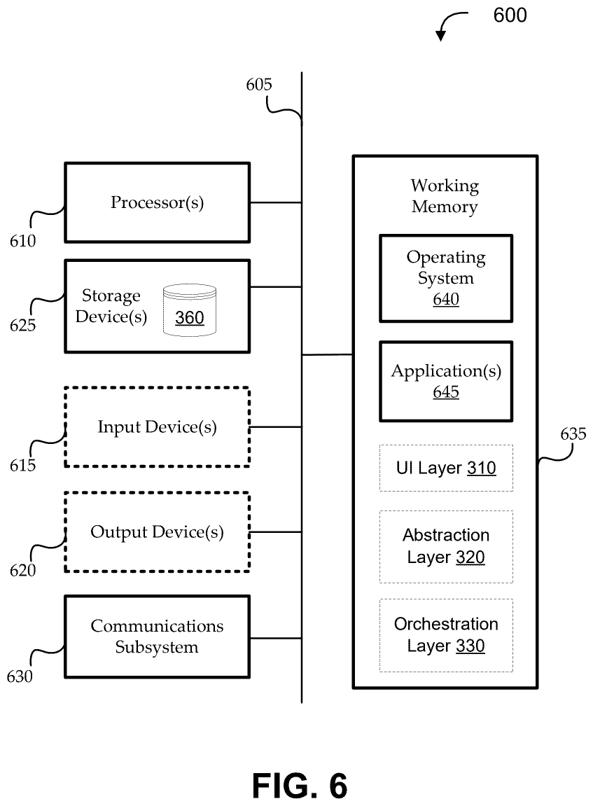

In some embodiments, the cellular testing platform described herein, or components thereof, can be implemented in a computational environment. FIG. 6 provides a schematic illustration of an embodiment of a computational system 600 that can implement various system components and/or perform various steps of methods provided by various embodiments. It should be noted that FIG. 6 is meant only to provide a generalized illustration of various components, any or all of which may be utilized as appropriate. FIG. 6, therefore, broadly illustrates how individual system elements may be implemented in a relatively separated or relatively more integrated manner.

Although illustrated as a single computational system 600, some or all of the system can be implemented in a cloud-based environment. In such an environment, computational resources, including processing and storing resources, can distributed across multiple servers, multiple locations, etc. Some implementations include a combination of on prem and cloud-based components.

The computational system 600 is shown including hardware elements that can be electrically coupled via a bus 605 (or may otherwise be in communication, as appropriate). The hardware elements may include one or more processors 610, including, without limitation, one or more general-purpose processors and/or one or more special-purpose processors (such as digital signal processing chips, graphics acceleration processors, video decoders, and/or the like). Optionally, embodiments of the computational system 600 can include one or more input devices 615, and/or one or more output devices 620. The input devices 615 can include user input devices (e.g., a mouse, a keyboard, remote control, touchscreen interfaces, audio interfaces, video interfaces, and/or the like) and/or machine input devices (e.g., computer-to-computer interfaces, such as wired and/or wireless input data ports). Similarly, the output devices 620 can include user output devices (e.g., display devices, printers, and/or the like), and/or machine input devices (e.g., computer-to-computer interfaces, such as wired and/or wireless output data ports).

The computational system 600 may further include (and/or be in communication with) one or more non-transitory storage devices 625, which can comprise, without limitation, local and/or network accessible storage, and/or can include, without limitation, a disk drive, a drive array, an optical storage device, a solid-state storage device, such as a random-access memory (“RAM”), and/or a read-only memory (“ROM”), which can be programmable, flash-updateable and/or the like. Such storage devices may be configured to implement any appropriate data stores, including, without limitation, various file systems, database structures, and/or the like. In some embodiments, the storage devices 625 include memory for storing the TaaS data platform 340 (e.g., TTT 342, NOL 344, etc.), database(s) 360, test corpus, topics, and/or any data used by embodiments described herein.

The computational system 600 can also include a communications subsystem 630, which can include, without limitation, a modem, a network card (wireless or wired), an infrared communication device, a wireless communication device, and/or a chipset (such as a Bluetooth™ device, an 802.11 device, a WiFi device, a WiMax device, cellular communication device, etc.), and/or the like. Depending on where in the network the computational system 600 is deployed, the communications subsystem 630 can include any suitable hardware and/or software components for communicating with other salient portions of the network.

The computational system 600 further includes a working memory 635, which can include a RAM or ROM device, as described herein. The computational system 600 also can include software elements, shown as currently being located within the working memory 635, including an operating system 640, device drivers, executable libraries, and/or other code, such as one or more application programs 645, which may include computer programs provided by various embodiments, and/or may be designed to implement methods, and/or configure systems, provided by other embodiments, as described herein. Merely by way of example, one or more procedures described with respect to the method(s) discussed herein can be implemented as code and/or instructions executable by a computer (and/or a processor within a computer); in an aspect, then, such code and/or instructions can be used to configure and/or adapt a general-purpose computer (or other device) to perform one or more operations in accordance with the described methods. As illustrated, the operating system 640 and the working memory 635 can be used in conjunction with the one or more processors 610 to implement the some or all components of one or more of the UI layer 310, abstraction layer 320, and/or orchestration layer 330. For example, the working memory 635 can be used to implement the portal 312, the chat bot 314, the O/A bots 345, the Taas orchestrator 335, automation engines, etc.

A set of these instructions and/or codes can be stored on a non-transitory (or non-transient) computer-readable storage medium, such as the non-transitory storage device(s) 625 described above. In some cases, the storage medium can be incorporated within a computer system, such as computational system 600. In other embodiments, the storage medium can be separate from a computer system (e.g., a removable medium, such as a compact disc), and/or provided in an installation package, such that the storage medium can be used to program, configure, and/or adapt a general-purpose computer with the instructions/code stored thereon. These instructions can take the form of executable code, which is executable by the computational system 600 and/or can take the form of source and/or installable code, which, upon compilation and/or installation on the computational system 600 (e.g., using any of a variety of generally available compilers, installation programs, compression/decompression utilities, etc.), then takes the form of executable code.

In some embodiments, the computational system 600 implements a portion of a system for communicating a data signal in a wireless communication network, as described herein. In some embodiments, the non-transitory storage device(s) 625 can have instructions stored thereon, which, when executed, cause the processor(s) 610 to perform steps of the method 500 of FIG. 5.

It will be apparent to those skilled in the art that substantial variations may be made in accordance with specific requirements. For example, customized hardware can also be used, and/or particular elements can be implemented in hardware, software (including portable software, such as applets, etc.), or both. Further, connection to other computing devices, such as network input/output devices, may be employed.

As mentioned above, in one aspect, some embodiments may employ a computer system (such as the computational system 600) to perform methods in accordance with various embodiments of the invention. According to a set of embodiments, some or all of the procedures of such methods are performed by the computational system 600 in response to processor 610 executing one or more sequences of one or more instructions (which can be incorporated into the operating system 640 and/or other code, such as an application program 645) contained in the working memory 635. Such instructions may be read into the working memory 635 from another computer-readable medium, such as one or more of the non-transitory storage device(s) 625. Merely by way of example, execution of the sequences of instructions contained in the working memory 635 can cause the processor(s) 610 to perform one or more procedures of the methods described herein.

The terms “machine-readable medium,” “computer-readable storage medium” and “computer-readable medium,” as used herein, refer to any medium that participates in providing data that causes a machine to operate in a specific fashion. These mediums may be non-transitory. In an embodiment implemented using the computational system 600, various computer-readable media can be involved in providing instructions/code to processor(s) 610 for execution and/or can be used to store and/or carry such instructions/code. In many implementations, a computer-readable medium is a physical and/or tangible storage medium. Such a medium may take the form of a non-volatile media or volatile media. Non-volatile media include, for example, optical and/or magnetic disks, such as the non-transitory storage device(s) 625. Volatile media include, without limitation, dynamic memory, such as the working memory 635. Common forms of physical and/or tangible computer-readable media include, for example, a floppy disk, a flexible disk, hard disk, magnetic tape, or any other magnetic medium, a CD-ROM, any other optical medium, any other physical medium with patterns of marks, a RAM, a PROM, EPROM, a FLASH-EPROM, any other memory chip or cartridge, or any other medium from which a computer can read instructions and/or code.

Various forms of computer-readable media may be involved in carrying one or more sequences of one or more instructions to the processor(s) 610 for execution. Merely by way of example, the instructions may initially be carried on a disk of a remote computer. The remote computer can load the instructions into its dynamic memory and send the instructions as signals over a transmission medium to be received and/or executed by the computational system 600. The communications subsystem 630 (and/or components thereof) generally will receive signals, and the bus 605 then can carry the signals (and/or the data, instructions, etc., carried by the signals) to the working memory 635, from which the processor(s) 610 retrieves and executes the instructions. The instructions received by the working memory 635 may optionally be stored on a non-transitory storage device 625 either before or after execution by the processor(s) 610.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of steps may be undertaken before, during, or after the above elements are considered.

What is claimed is:

1. A method for testing cellular network components using a cellular test environment having a test platform, a plurality of vendor test equipment platforms (VTEs), and a laboratory end-to-end (E2E) cellular network (LEEN), method comprising:
receiving, by an orchestration layer of the test platform via a user interface (UI) of a UI layer of the test platform, a request to initiate a test of a device under test (DUT) and vendor-agnostic test campaign data defining the DUT and test parameters, the DUT being a cellular network component;
selecting, by the orchestration layer, a VTE of the plurality of VTEs for execution of the test, based at least on matching features of the selected VTE to the vendor-agnostic test campaign data, each of the plurality of VTEs operating according to a respective input/output (I/O) interface scheme;
translating, by an abstraction layer of the test platform, the vendor-agnostic test campaign data into vendor-specific test campaign data compatible with the respective I/O interface scheme of the selected VTE based on a set of application programming interfaces (APIs); and
directing, by the orchestration layer, the selected VTE to execute the test on the DUT in the LEEN based on the vendor-specific test campaign data.

2. The method of claim 1, further comprising:
receiving, by the orchestration layer, test results based on execution of the test by the selected VTE; and
publishing the test results from the orchestration layer to the UI layer for output via the UI.

3. The method of claim 1, wherein the request to initiate the test of the DUT comprises a selected test of a plurality of tests selected from a stored test corpus accessible by the plurality of VTEs.

4. The method of claim 1, wherein:
the UI layer comprises a web portal and a chat bot, the chat bot being a machine learning network trained as a large language model for automatically processing natural language; and
the request to initiate the test of the DUT is received by the chat bot via the web portal as a natural language query from a user and is translated into a processor-readable request to initiate the test of the DUT.

5. The method of claim 1, wherein the DUT is a radio access network (RAN) component.

6. The method of claim 1, wherein the DUT is a core network component.

7. The method of claim 1, wherein the DUT is a transport network component.

8. A platform for testing cellular network components in a cellular test environment having a plurality of vendor test equipment platforms (VTEs), and a laboratory end-to-end (E2E) cellular network (LEEN), each of the plurality of VTEs operating according to a respective input/output (I/O) interface scheme, the platform comprising:
a user interface (UI) layer configured to receive a request to initiate a test of a device under test (DUT) and vendor-agnostic test campaign data defining the DUT and test parameters, the DUT being a cellular network component;
an abstraction layer configured to translate the vendor-agnostic test campaign data into vendor-specific test campaign data compatible with the respective input/output (I/O) interface scheme of any of the plurality of VTEs based on set of application programming interfaces (APIs); and
an orchestration layer configured to:
receive the request and the vendor-agnostic test campaign data from the UI layer;
select a VTE of the plurality of VTEs for execution of the test, based at least on matching features of the selected VTE to the vendor-agnostic test campaign data;
direct the abstraction layer to of the test platform, the vendor-agnostic test campaign data into the vendor-specific test campaign data compatible with the respective I/O interface scheme of the selected VTE; and
direct the selected VTE to execute the test on the DUT in the LEEN based on the vendor-specific test campaign data.

9. The platform of claim 8, wherein the orchestration layer is further configured to:
receive test results based on execution of the test by the selected VTE; and
publish the test results to the UI layer for output.

10. The platform of claim 8, wherein:
the orchestration layer comprises a stored test corpus accessible by the plurality of VTEs and comprising a plurality of predefined tests; and
the request to initiate the test of the DUT indicates a selected test of the plurality of predefined tests selected from the stored test corpus.

11. The platform of claim 8, wherein:
the UI layer comprises a web portal and a chat bot, the chat bot being a machine learning network trained as a large language model for automatically processing natural language; and
the request to initiate the test of the DUT is received by the chat bot via the web portal as a natural language query from a user and is translated into a processor-readable request to initiate the test of the DUT.

12. The platform of claim 8, wherein the DUT is one of a centralized unit, a distributed unit, or a radio unit.

13. The platform of claim 8, wherein the DUT is a core network component or a transport network component.

14. A cellular test environment for testing cellular network components, the cellular test environment in communication with a plurality of vendor test equipment platforms (VTEs) and a laboratory end-to-end (E2E) cellular network (LEEN), cellular test environment comprising:
one or more processors; and
non-transitory, processor-readable memory having instructions stored thereon, which, when executed, cause the one or more processors to perform steps comprising:
receiving a request to initiate a test of a device under test (DUT) and vendor-agnostic test campaign data defining the DUT and test parameters, the DUT being a cellular network component;
selecting a VTE of the plurality of VTEs for execution of the test, based at least on matching features of the selected VTE to the vendor-agnostic test campaign data, each of the plurality of VTEs operating according to a respective input/output (I/O) interface scheme;
translating the vendor-agnostic test campaign data into vendor-specific test campaign data compatible with the respective I/O interface scheme of the selected VTE based on set of application programming interfaces (APIs); and
directing the selected VTE to execute the test on the DUT in the LEEN based on the vendor-specific test campaign data.

15. The cellular test environment of claim 14, wherein the steps further comprise:
receiving test results based on execution of the test by the selected VTE; and
publishing the test results to a user interface for output.

16. The cellular test environment of claim 14, wherein:
the memory further has, stored thereon, a test corpus comprising a plurality of predefined tests; and
the request to initiate the test of the DUT identifies a selected test of the plurality of tests of the test corpus.

17. The cellular test environment of claim 14, wherein:
the request to initiate the test of the DUT is received by a chat bot via a web portal as a natural language query from a user and is translated by the chat bot into a processor-readable request to initiate the test of the DUT, the chat bot being a machine learning network trained as a large language model for automatically processing natural language.

18. The cellular test environment of claim 14, wherein the DUT is a radio access network (RAN) component.

19. The cellular test environment of claim 14, wherein the DUT is a core network component.

20. The cellular test environment of claim 14, wherein the DUT is a transport network component.
